(19) United States
(12) Patent Application Publication
(10) Pub. No.: US 2009/0208087 A1
(43) Pub. Date: Aug. 20, 2009

(54) RADIOGRAPHIC IMAGE CORRECTION METHOD, APPARATUS AND RECORDING-MEDIUM STORED THEREIN PROGRAM

(75) Inventor: Takaaki SAITO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/371,279

(22) Filed: Feb. 13, 2009

(30) Foreign Application Priority Data
Feb. 14, 2008 (JP) 2008-032784
May 29, 2008 (JP) 2008-140959
Feb. 6, 2009 (JP) 2009-025677

(51) Int. Cl. G06K 9/00

(52) U.S. Cl. 382/132

(57) ABSTRACT

Unevenness in the density of a radiographic image of a subject that has been obtained by outputting radiation from a radiation output unit toward the subject and by detecting the radiation at a radiographic image detector is corrected. An area that has substantially the same density throughout the area when the radiation output by the radiation output unit is uniform with respect to the entire area of the radiographic image detector and that is present in a subject-image-present area is obtained from the radiographic image. Further, the pixel values of the radiographic image are corrected by using pixel values of the obtained area.

### BACKGROUND OF THE INVENTION

1. Field of the Invention

The present invention relates to a radiographic image correction method and apparatus that corrects pixel values of a radiographic image of a subject, the radiographic image being obtained by outputting radiation from a radiation output means toward the subject and by detecting the radiation at a radiographic image detector. Further, the present invention relates to a computer-readable recording medium stored therein a program for the method and the apparatus.

2. Description of the Related Art

In radiographic imaging (radiography) for medical diagnosis, a radiographic image detector that obtains a radiographic image of a subject by detecting radiation output from a radiation output means toward the subject and by converting the detected radiation into an electric signal is well known. Examples of the radiographic image detector are a CR (computed radiography) type radiographic image detector using a photostimulable phosphor (stimulable phosphor or energy-storable phosphor), a radiographic image detector using a solid-state sensor and the like. The photostimulable phosphor, which is used in the radiographic image detector using the photostimulable phosphor, stores a part of radiation energy received by irradiation with radiation, and emits photostimulated light corresponding to the stored energy by irradiation with stimulating light (excitation light), such as visible light. In the radiographic image detector using the photostimulable phosphor, a radiographic image of a subject is temporarily stored in a photostimulable phosphor sheet. Further, the photostimulable phosphor sheet is scanned with the stimulating light, such as a laser beam, to cause the photostimulable phosphor sheet to emit photostimulated light. Further, the photostimulated light is detected to obtain image signals representing the radiographic image. In the radiographic image detector using the solid-state sensor, a solid-state sensor that generates charges corresponding to radiation energy received by irradiation with radiation is used. The radiographic image detector using the solid-state sensor converts a radiographic image of a subject into charges, and stores the charges. Further, the radiographic image detector using the solid-state sensor reads out the stored charges by using a thin film transistor or a semiconductor material that generates charges by irradiation with light.

In radiography, unevenness in the intensity of radiation output from a radiation output means, unevenness in the sensitivity of the radiographic image detector at the light-receiving surface thereof, and the like prevent obtainment of accurate radiographic image information about a subject.

To solve such problems in radiography, U.S. Pat. No. 4,755,672 proposes a method for correcting image signals of a radiographic image. In U.S. Pat. No. 4,755,672, correction data is generated based on a radiographic image that has been obtained in advance by imaging without passing radiation through a subject. Further, the correction data is used to correct image signals of a radiographic image that has been obtained by passing radiation through the subject.

The method disclosed in U.S. Pat. No. 4,755,672 can correct recurrent unevenness, which recurs or repeats (reappears) in the same manner every time a radiographic image is obtained. However, the method cannot correct non-recurrent unevenness (non-recurrent unevenness, which does not recur nor repeat (reappear)) that is generated irregularly in such a manner that the unevenness differs every time of radiography.

Meanwhile, Japanese Patent No. 3765155 proposes a method for correcting non-recurrent unevenness. In Japanese Patent No. 3765155, a profile is generated by adding the signal value of each pixel of the radiographic image in the horizontal direction thereof (or vertical direction thereof). Further, a position at which the profile sharply changes is extracted from the profile, and the image signals of the radiographic image are corrected so that the sharp change in the profile at the extracted position becomes smooth. Accordingly, the non-recurrent unevenness, which is caused by vibration generated at the time of photoelectric conversion, dust or particles attached to an optical system that is used to read out image signals from a photostimulable phosphor sheet, the movement of the dust or particles, or the like can be corrected.

In B. A. Varela et al., “Preprocessing of Radiological Images: Comparison of the Application of Polynomic Algorithms and Artificial Neural Networks to the Elimination of Variations in Background Luminosity”, Lect. Notes Comput. Sci. 1607, pp. 452-459, 1999, a method for correcting non-recurrent unevenness in the density of a radiographic image is proposed. In the proposed method, correction data that approximates the unevenness in the density of the radiographic image is generated by using the pixel values of a so-called non-subject-imaged area (empty area) of the radiographic image, in which radiation enters directly. Further, the correction data is subtracted from the radiographic image to correct the non-recurrent unevenness in the density of the radiographic image.

When a mobile diagnosis cart (a portable cart for doctor's visits to patients' rooms that can be used to obtain a radiographic image or the like) is used to perform radiography at a patient's room or the like, the conditions of radiography are different from the conditions of radiography performed in an X-ray room, which is a special room for X-ray radiography or the like. In the patient's room, a radiographic image detector, such as an imaging plate (stimulable phosphor sheet) and a flat panel detector, is placed on the back side of the patient who is lying on a bed to perform radiography. Therefore, radiography is affected by the surrounding conditions of the patient, such as the softness of the bed. Further, the position and the arrangement direction of the radiographic image detector with respect to the direction of radiation output from the radiation output means may be shifted irregularly, in other words, in a different manner each time of radiography. Hence, in radiography using the mobile diagnosis cart, non-recurrent unevenness in density, in which the density gradually (smoothly) changes through the entire area of a radiographic image obtained by radiography, is generated in some cases.

However, in the method disclosed in Japanese Patent No. 3765155, a position at which the generated profile sharply changes is extracted from the profile, and the image signals are corrected so that the sharp change in the profile at the extracted position becomes smooth. Therefore, the method disclosed in Japanese Patent No. 3765155 cannot correct the aforementioned non-recurrent unevenness, in which the density gradually (smoothly) changes through the entire area of the radiographic image.

Further, in the method proposed by B. A. Varela et al., the correction data that approximates the unevenness in the density in the entire area of the radiographic image is generated by using the pixel values of the non-subject-imaged area. Therefore, it is necessary that the non-subject-imaged area in the radiographic image is sufficiently large or spreads to obtain the correction data. However, there are cases in which the radiographic image includes no non-subject-imaged area, or even if a non-subject-imaged area is present in the radiographic image, the size of the non-subject-imaged area may be too small. In such cases, it is impossible to correct the non-recurrent unevenness in density in the entire area of the radiographic image.

### SUMMARY OF THE INVENTION

In view of the foregoing circumstances, it is an object of the present invention to provide an image correction method and apparatus that can correct unevenness in the density of a radiographic image, particularly non-recurrent unevenness in the density thereof, regardless of whether a non-subject-imaged area is present in the radiographic image. Further, it is another object of the present invention to provide a computer-readable recording medium stored therein a program for the image correction method and apparatus.

A radiographic image correction method of the present invention is a radiographic image correction method for correcting pixel values of a radiographic image of a subject, the radiographic image having been obtained by outputting radiation from a radiation output means toward the subject and by detecting the radiation at a radiographic image detector, the method comprising the steps of:

obtaining an area that has substantially the same density (pixel value) throughout the area when the radiation output by the radiation output means is uniform with respect to the entire area of the radiographic image detector and that is present in a subject-image-present area of the radiographic image; and

correcting the pixel values of the radiographic image by using pixel values of the obtained area.

A radiographic image correction apparatus of the present invention is a radiographic image correction apparatus for correcting pixel values of a radiographic image of a subject, the radiographic image having been obtained by outputting radiation from a radiation output means toward the subject and by detecting the radiation at a radiographic image detector, the apparatus comprising:

an area obtainment means that obtains an area that has substantially the same density throughout the area when the radiation output by the radiation output means is uniform with respect to the entire area of the radiographic image detector and that is present in a subject-image-present area of the radiographic image; and

a correction means that corrects the pixel values of the radiographic image by using pixel values of the obtained area.

In the radiographic image correction apparatus, the radiographic image may be a radiographic image of an anterior view of the chest of a human body, and the area obtainment means may obtain, as the area that has substantially the same density throughout the area, overlapped-ribs-image-present areas from the radiographic image of the anterior view of the chest, overlapped ribs in the overlapped-ribs-image-present areas being present in a left lateral-border (lateral-contour) region of the thorax of the human body and in a right lateral-border (lateral-contour) region thereof.

Further, the radiographic image correction apparatus may further include an area specifying information input means that is used to input information specifying the area that has substantially the same density throughout the area, and the area obtainment means may obtain the area that has substantially the same density throughout the area based on the information input by the area specifying information input means.

Further, the correction means may obtain a linear function that approximates unevenness in the density of the radiographic image by using pixel values of the area that has substantially the same density throughout the area, and correct the pixel values of the radiographic image by using the obtained linear function.

Further, the correction means may obtain a linear function that approximates unevenness in the density of the radiographic image by using pixel values of the overlapped-ribs-image-present areas when at least one of the lengths of the overlapped-ribs-image-present areas in the longitudinal direction thereof is less than or equal to a predetermined threshold value, and correct the pixel values of the radiographic image by using the obtained linear function. The correction means may obtain a non-linear function that approximates the unevenness in the density of the radiographic image by using pixel values of the overlapped-ribs-image-present areas when both of the lengths of the overlapped-ribs-image-present areas in the longitudinal direction thereof are greater than the predetermined threshold value, and correct the pixel values of the radiographic image by using the obtained non-linear function.

The radiographic image correction apparatus may further include:

a display means that displays a parameter of the function that approximates the unevenness in the density; and

a corrected-value input means that is used to input a corrected value to correct the parameter displayed by the display means. Further, the correction means may correct the parameter by using the corrected value input by the corrected-value input means, and correct the pixel values of the radiographic image by using a function defined by the corrected parameter.

Further, the radiographic image correction apparatus may further include a storage means that stores the function that has been used by the correction means to correct the pixel values in such a manner that the function relates to the radiographic image, the pixel values of which have been corrected by using the function.

Further, the radiographic image may be a radiographic image of an anterior view of the chest of a human body, and the correction means may extract a body axis of the human body from the radiographic image of the anterior view of the chest, and obtain a function that approximates unevenness in the density of the radiographic image of the anterior view of the chest, the unevenness in the density being present in a direction orthogonal to the extracted body axis, by using the pixel values of the area that has substantially the same density throughout the area, and correct pixel values of the radiographic image of the anterior view of the chest by using the obtained function.

Further, the radiographic image correction apparatus may further include a target specifying information input means that is used to input information that specifies whether both of unevenness in the density of the radiographic image, the unevenness in the density being present in the direction of the body axis, and the unevenness in the density in the direction orthogonal to the body axis, or only the unevenness in the density in the direction orthogonal to the body axis is a target of correction processing by the correction means. Further, the correction means may obtain, based on the information input by the target specifying information input means, one of a function that approximates both of the unevenness in the density in the direction of the body axis and the unevenness in the density in the direction orthogonal to the body axis and a function that approximates the unevenness in the density in the direction orthogonal to the body axis, and correct the pixel values of the radiographic image by using the obtained function.

A computer-readable recording medium stored therein a radiographic image correction program of the present invention may be a computer-readable recording medium stored therein a radiographic image correction program for causing a computer to execute radiographic image correction processing for correcting pixel values of a radiographic image of a subject, the radiographic image having been obtained by outputting radiation from a radiation output means toward the subject and by detecting the radiation at a radiographic image detector, the program comprising the procedures of:

obtaining an area that has substantially the same density throughout the area when the radiation output by the radiation output means is uniform with respect to the entire area of the radiographic image detector and that is present in a subject-image-present area of the radiographic image; and

correcting the pixel values of the radiographic image by using pixel values of the obtained area.

The area that has substantially the same density throughout the area is an area in which the ratio of the maximum value of the radiation dose detected in the area to the minimum value of the radiation dose detected in the area is approximately 2:1 (twice) or less. Further, the density (pixel value) of the radiographic image is obtained by logarithmically converting the ratio of the detected radiation doses into a space in which the ratio is expressed as a difference.

Further, it is desirable that the area that has substantially the same density throughout the area is sufficiently large or spread to obtain a function that approximates the unevenness in the density in the entire area of the radiographic image.

Further, the expression “the radiation output by the radiation output means is uniform with respect to the entire area of the radiographic image detector” means that if a subject is not present at the time of radiation, the entire area of the radiographic image detector is evenly irradiated with radiation that has the same dose.

Further, the term “entire area of the radiographic image detector” refers to a substantial image-signal detection area.

Further, the term “radiographic image detector” refers to an imaging plate, a flat panel detector and the like.

According to a radiographic image correction method and apparatus and a computer-readable recording medium stored therein a program for the radiographic image correction method and apparatus of the present invention, when pixel values of a radiographic image of a subject, the radiographic image having been obtained by outputting radiation from a radiation output means toward the subject and by detecting the radiation at a radiographic image detector, are corrected, an area that has substantially the same density throughout the area when the radiation output by the radiation output means is uniform with respect to the entire area of the radiographic image detector and that is present in a subject-image-present area of the radiographic image is obtained. Further, the pixel values of the radiographic image are corrected by using pixel values of the obtained area. Therefore, it is possible to correct even non-recurrent unevenness in the density in the entire area of the radiographic image, regardless of whether a non-subject-imaged area is present in the radiographic image. The unevenness in the density can be corrected based on the influence of unevenness in irradiation (irradiation dose) that appears as unevenness in the pixel values of an area in which the density should be substantially the same throughout the area if the radiation is output uniformly.

Further, in the radiographic image correction method and apparatus and the computer-readable recording medium stored therein the program for the method and apparatus of the present invention, overlapped-ribs-image-present areas may be obtained, as the area that has substantially the same density throughout the area, from the radiographic image of the anterior view of the chest, overlapped ribs in the overlapped-ribs-image-present areas being present in a left lateral-border region of the thorax of the human body and in a right lateral-border region thereof. The overlapped-ribs-image-present areas are areas in the radiographic image in which the density is substantially the same throughout the areas when the intensity of radiation output from the radiation output means toward the subject is uniform throughout the entire area of the radiographic image detector.

Those who are skilled in the art would know that computer-readable recording media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also throughout the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a radiographic image correction apparatus according to an embodiment of the present invention;

FIG. 2 is a diagram for explaining processing for correcting a radiographic image by the radiographic image correction apparatus illustrated in FIG. 1;

FIG. 3 is a diagram for explaining processing for correcting unevenness in density that is present in a direction orthogonal to the body axis of a subject;

FIG. 4 is a diagram illustrating an example of display of parameters of a function that approximates unevenness in density; and

FIG. 5 is a diagram illustrating shoulder-blade-image-present areas, which have substantially the same density throughout the areas.

### DESCRIPTION OF THE PREFERRED EMBODIMENTS

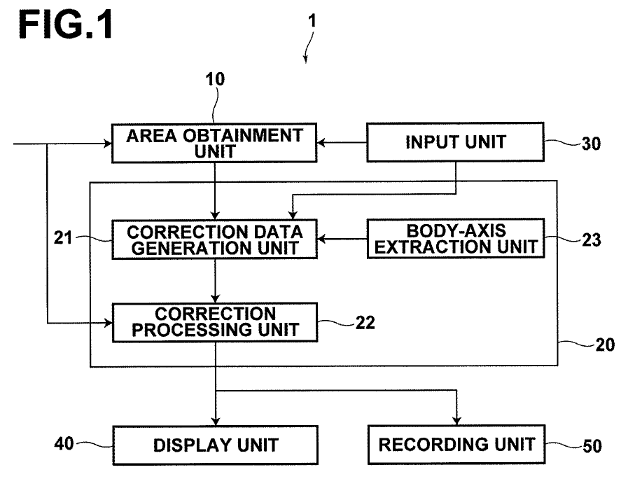

Hereinafter, embodiments of a radiographic image correction apparatus of the present invention will be described with reference to drawings. FIG. 1 is a diagram illustrating a radiographic image correction apparatus 1 according to an embodiment of the present invention. The configuration of the radiographic image correction apparatus 1 may be realized by causing a computer (for example, a personal computer or the like) to execute a radiographic image correction program installed in an auxiliary recording apparatus (supplementary storage apparatus). The radiographic image correction program may be stored in an information recording medium, such as a CD-ROM (compact disk read-only memory), or distributed through a network, such as the Internet, to be installed in a computer.

As illustrated in FIG. 1, the radiographic image correction apparatus 1 corrects the pixel values of a radiographic image of a subject, the radiographic image having been obtained by detecting, at a radiographic image detector, radiation that has been output from a radiation output means toward the subject. The radiographic image correction apparatus 1 includes an area obtainment unit 10, a correction unit 20, an input unit 30, a display unit 40, a storage unit 50 and the like.

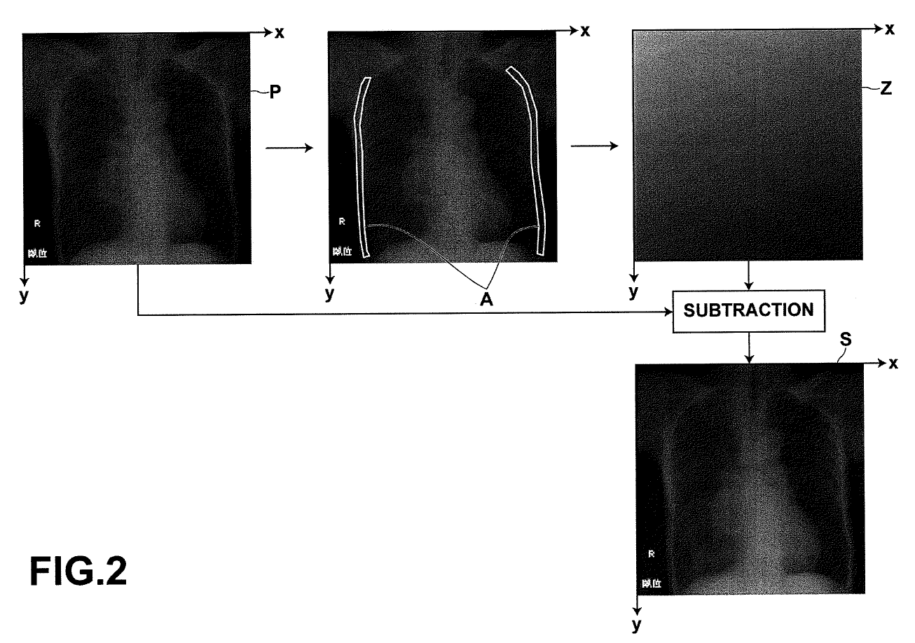

The area obtainment unit 10 obtains an area that has substantially the same density throughout the area when the radiation output by the radiation output means is uniform with respect to the entire area of the radiographic image detector and that is present in a subject-image-present area of the radiographic image. For example, as illustrated in FIG. 2, when the radiographic image is a radiographic image of an anterior view of the chest of a human body, the area obtainment unit 10 obtains, as the area that has substantially the same density throughout the area, overlapped-ribs-image-present areas A (areas enclosed by solid white lines in FIG. 2) from the radiographic image of the anterior view of the chest. The overlapped ribs in the overlapped-ribs-image-present areas are present in a left lateral-border region of the thorax of the human body and in a right lateral-border region thereof.

The area obtainment unit 10 may obtain the area that has substantially the same density throughout the area by automatically detecting the area as described above. Alternatively, the area obtainment unit 10 may receive information specifying the area that has substantially the same density throughout the area, the information being input by a user by using the input unit 30. Further, the area obtainment unit 10 may obtain the area that has substantially the same density throughout the area based on the received information. Here, the information specifying the area that has substantially the same density directly designates (indicates) the area that has substantially the same density. For example, the information includes information about the positions of points assigned so as to surround (enclose) the area that has substantially the same density throughout the area, information about an area assigned, as the area that has substantially the same density throughout the area, by painting the entire area thereof or the like. The information should specify the area in such a manner that the area is uniquely identified based on the information.

When the area obtainment unit 10 automatically detects, as the area that has substantially the same density throughout the area, overlapped-ribs-image-present areas (areas of a radiographic image, in each of which an image of overlapped ribs of a subject is present), a technique disclosed in Japanese Unexamined Patent Publication No. 2003-006661 may be used. Specifically, an area enclosed by the lateral border (lateral contour or outer border), the medial border (medial contour or inner border) and the inferior border (inferior contour or lower border) of the right lung of a subject and the lateral border, the medial border and the inferior border of the left lung of the subject is determined. Further, an area on the right side of the determined area (an area continuing from or in the vicinity of the right border of the determined area) and an area on the left side of the determined area (an area continuing from or in the vicinity of the left border of the determined area) are extracted. The areas are extracted so that each of the extracted areas substantially has a width that an overlapped-ribs-image-present area generally has. Accordingly, the overlapped-ribs-image-present areas are obtained. Further, the method for obtaining the overlapped-ribs-image-present areas and the method for obtaining the area that has substantially the same density throughout the area are not limited to the aforementioned methods. The overlapped-ribs-image-present areas and the area that has substantially the same density throughout the area may be obtained by using other methods.

The correction unit 20 includes a correction data generation unit 21, a correction processing unit 22 and a body-axis extraction unit 23. The correction data generation unit 21 generates correction data that approximates unevenness in the density of the radiographic image by using pixel values of the area that has substantially the same density throughout the area, which has been obtained by the area obtainment unit 10. The correction processing unit 22 corrects the pixel values of the radiographic image by using the generated correction data. The body-axis extraction unit 23 extracts the body axis of a human body from a radiographic image of an anterior view of the chest of the human body.

First, the correction data generation unit 21 generates linear model Z′(x, y), which approximates pixel values in the area that has substantially the same density throughout the area, as the following equation (1) represents:

Z′(x,y)=ax+by+c (1).

In equation (1), constants a, b and c are parameters selected so that the equation (1) forms the most reliable linear model (most likely linear model), for example, by using a least square method. Specifically, the constants a, b and c are obtained by searching for the parameters that can minimize the sum of the squares of differences between the pixel value A(x, y) of each pixel in the area that has substantially the same density throughout the area and the value of Z′(x, y).

Next, the correction data generation unit 21 generates, as correction data, linear model Z(x, y), which approximates unevenness in the density of the radiographic image with respect to the horizontal direction x of the radiographic image and with respect to the vertical direction y thereof, as the following equation (2) represents:

Z(x,y)=a(x−xc)+b(y−yc) (2).

The linear model Z(x, y) is generated by using the obtained parameters a and b and the coordinate (xc, yc) of the center of the radiographic image. Further, the correction data generation unit 21 outputs the generated correction data to the correction processing unit 22.

Image Z illustrated in FIG. 2 is an example of the correction data obtained by approximating the unevenness in the density of radiographic image P, which is a radiographic image of an anterior view of the chest, by a linear function. The correction data is obtained by using the pixel value of each pixel within areas A, which are overlapped-ribs-image-present areas (areas of a radiographic image, in each of which an image of overlapped ribs of a subject is present), in the radiographic image P. The overlapped ribs in the human body are present in a left lateral-border region of the thorax of the human body and in a right lateral-border region thereof.

Here, a case in which the correction data generation unit 21 generates the correction data by approximating the unevenness in the density of the radiographic image by a linear function has been described. Alternatively, the correction data generation unit 21 may generate correction data by approximating the unevenness in the density of the radiographic image by a linear function when at least one of the lengths of the areas A, overlapped-ribs-image-present areas, in the longitudinal direction thereof is less than or equal to a predetermined threshold value, and the correction data generation unit 21 may generate correction data by approximating the unevenness in the density of the radiographic image by a non-linear function when both of the lengths of the areas A, overlapped-ribs-image-present areas, in the longitudinal direction thereof are greater than a predetermined threshold value. For example, when the body axis of the subject passes the center of the radiographic image and extends in the vertical direction y of the radiographic image, if at least one of the lengths of the areas A, overlapped-ribs-image-present areas, in the longitudinal direction thereof are less than or equal to 70% of the length of the radiographic image in the vertical direction y thereof, the correction data generation unit 21 may generate the correction data by approximating the unevenness in the density of the radiographic image by a linear function. In contrast, if both of the lengths of the areas A in the longitudinal direction thereof are greater than 70% of the length of the radiographic image in the vertical direction y thereof, the correction data generation unit 21 may generate the correction data by approximating the unevenness in the density of the radiographic image by a non-linear function.

Next, a method for generating a non-linear model that approximates the unevenness in the density of the radiographic image will be described. First, the correction data generation unit 21 generates non-linear model Z′(x, y), which approximates image signals in the area that has substantially the same density throughout the area, for example, as the following equation (3) represents:

Z′(x,y)=A(x−xc){(y−yc)²+B(y−yc)+C}+D (3).

In the equation (3), constants A, B, C and D are parameters selected by using a least square method so that the equation (3) forms the most reliable non-linear model Z′(x, y) in a manner similar to the case of the aforementioned linear model.

Next, the correction data generation unit 21 generates, as correction data, non-linear model Z(x, y), which approximates the unevenness in the density of the radiographic image with respect to the horizontal direction x of the radiographic image and with respect to the vertical direction x thereof, as the following equation (4) represents:

Z(x,y)=A(x−xc){(y−yc)²+B(y−yc)+C} (4).

The non-linear model Z(x, y) is generated by using the obtained parameters A, B and C and the coordinate (xc, yc) of the center of the radiographic image. Further, the correction data generation unit 21 outputs the generated correction data to the correction processing unit 22.

Here, the density in each of the areas A, overlapped-ribs-image-present areas, changes in the body-axis direction of the subject in some cases, depending on the physique (habitus or body shape) of the subject. Therefore, when the correction data is generated by using the pixel values in the areas A, only the unevenness in density that is present in a direction orthogonal to the body axis may be the target of correction. If the target of correction is limited in such a manner, it is possible to exclude the unevenness in density caused by the physique of the subject from the target of correction.

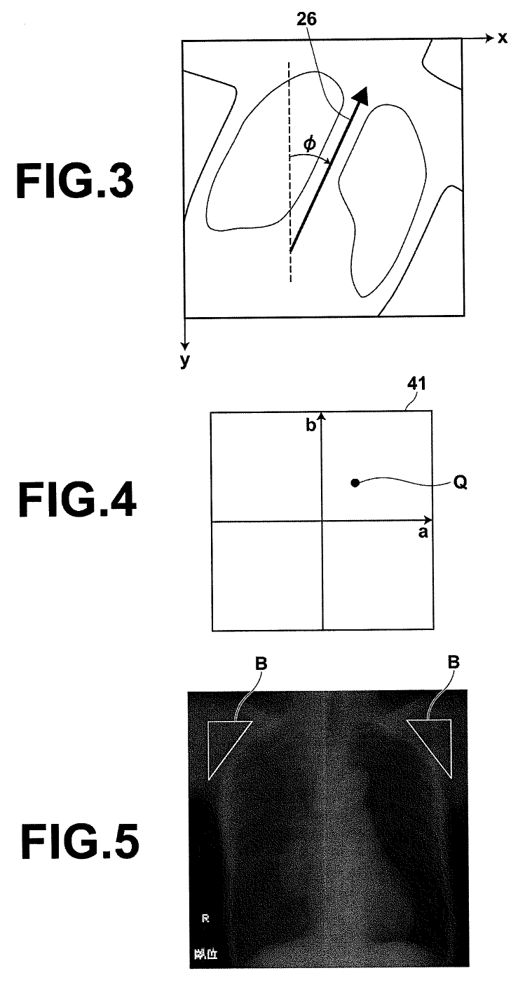

Next, with reference to FIG. 3, a method for obtaining correction data that approximates only the unevenness in density in the direction orthogonal to the body axis will be described.

First, the body-axis extraction unit 23 extracts the body axis 26 of a human body from a radiographic image of an anterior view of the chest of a subject. For example, as disclosed in the specification of Japanese Patent Application No. 2008-037145, the body-axis extraction unit 23 extracts an edge component value for each pixel of the chest image by using a Gabor filter. The edge component value includes an edge direction value corresponding to the width of the vertebral body of the subject and an edge intensity value corresponding to the width of the vertebral body of the subject. Next, an area in the chest image, the area that does not include at least left and right side edge regions, in which the collarbones (clavicles) and the ribs of the subject overlap with each other, is set as a region of interest. Then, an edge direction value corresponding to the highest edge intensity value at each of pixels in the region of interest is weighted by the highest edge intensity value at the respective pixels and averaged, and the obtained direction is estimated as the direction of the vertebral body. Next, the chest image is scanned in a direction that is substantially perpendicular to the estimated direction of the vertebral body to extract, as a vertebral body region, pixels that have pixel values lower than or equal to a predetermined value. Further, the median line of the extracted vertebral body region is detected as the median line of the human body.

Next, the correction data generation unit 21 obtains an inclination angle φ of the body axis 26 of the subject with respect to the axis y of the image. Further, the correction data generation unit 21 generates linear model Z′(x, y), which approximates the image signals in an area that has substantially the same density throughout the area, as the following equation (5) represents:

Z′(x,y)=(acosφ)x+(asinφ)y+c (5).

In the equation (5), constants a and c are selected by using a least square method so that the equation (5) forms the most reliable linear model Z′(x, y) in a manner similar to the case of the aforementioned other correction data generation methods.

Next, the correction data generation unit 21 generates, as correction data, linear model Z(x, y), which approximates the unevenness in the density of the radiographic image with respect to a direction orthogonal to the body axis, as the following equation (6) represents:

Z(x,y)=(acosφ)(x−xc)+(asin φ)(y−yc) (6).

When the pixel values of a radiographic image of an anterior view of the chest of a subject are corrected by using the pixel values of areas A, overlapped-ribs-image-present areas, both of the unevenness in the density of the radiographic image in the direction of the body axis and the unevenness in the density of the radiographic image in the direction orthogonal to the body axis may be corrected. Alternatively, only the unevenness in the density of the radiographic image in the direction orthogonal to the body axis may be corrected. Whether both of the unevenness in the density of the radiographic image in the direction of the body axis and the unevenness in the density of the radiographic image in the direction orthogonal to the body axis are a target of correction by the correction unit or only the unevenness in the density of the radiographic image in the direction orthogonal to the body axis is the target of correction by the correction unit may be automatically determined based on the magnitude of the gradient of the density in the areas A with respect to the direction of the body axis. Alternatively, the target of correction may be determined based on information input by a user by using the input unit 30, the information specifying the target of correction, i.e., whether both of the unevenness in the density of the radiographic image in the direction of the body axis and the unevenness in the density of the radiographic image in the direction orthogonal to the body axis are a target of correction or only the unevenness in the density of the radiographic image in the direction orthogonal to the body axis is the target of correction is a target of correction, or the like. Here, information that specifies the target of correction is, for example, setting information that has been set by a user by selecting specific unevenness in the density to be corrected, namely the unevenness in the density in the two directions or the unevenness in the density in the direction orthogonal to the body axis, in a setting screen displayed by the display unit 40.

Further, the parameters of the function (correction data) that approximates the unevenness in density, as described above, are displayed on a monitor (not illustrated) by the display unit 40. When the user inputs a corrected value or corrected values for the parameters displayed on the screen by using the input unit 30, the correction data generation unit 21 receives the corrected value or corrected values input by the user from the input unit 30. Further, the correction data generation unit 21 corrects the parameter or parameters by using the input corrected value or values. Further, the correction data generation unit 21 may output, as correction data, a function defined by the corrected parameter or parameters to the correction processing unit 22.

FIG. 4 is a diagram illustrating an example of display of parameters a and b of a linear function that approximates the unevenness in density, which are displayed on a monitor of the display unit 40. The user can move point Q, which is defined by the values of the parameters a and b, in a graph 41 by using a cursor or by specifying a new position or the like. Accordingly, the user can correct the values of the parameters a and b so that the values become desirable values.

The correction processing unit 22 corrects pixel values of the radiographic image by using correction data generated by the correction data generation unit 21. As illustrated in FIG. 2, the correction processing unit 22 generates corrected image S, unevenness in the density of which has been corrected, by calculating each pixel value S(x, y), the unevenness in the density of which is corrected. The pixel value S(x, y) is obtained by subtracting the correction data Z(x, y) generated by the correction data generation unit 21 from each pixel P(x, y) of the radiographic image P.

The corrected image S that has been generated as described above is displayed on a monitor of the display unit 40. At this time, parameters of the correction data Z(x, y) that have been used for correction processing by the correction processing unit 22, information, such as the border of an area that has substantially the same density throughout the area, the area having been used to generate the correction data Z(x, y) may be displayed on the monitor. If these kinds of information are displayed, the user can easily recognize the content of correction processing performed on the image.

Further, when the user inputs a corrected value for the parameter displayed on the screen by using the input unit 30, the correction data generation unit 21 receives the corrected value input by the user from the input unit 30. Further, the correction data generation unit 21 corrects the parameter by using the corrected value that has been input. Further, the correction processing unit 22 corrects the pixel values of the radiographic image again by using a function defined by the corrected parameter or parameters to generate corrected image S, the unevenness in the density of which has been corrected.

Further, the recording unit 50 (storage means) stores the radiographic image S on which correction processing has been performed as described above and correction data Z(x, y) that has been used for the correction processing. The recording unit 50 stores the radiographic image S and the correction data Z(x, y) in a recording medium in such a manner that they relate to each other.

In the configuration of the present invention as described above, when the pixel values of a radiographic image obtained by outputting radiation from a radiation output means toward the subject and by detecting the radiation at a radiographic image detector are corrected, processing is performed in the following manner. First, the area obtainment unit 10 obtains an area that has substantially the same density throughout the area when the radiation output by the radiation output means is uniform with respect to the entire area of the radiographic image detector and that is present in a subject-image-present area in a radiographic image P. Next, the correction data generation unit 21 generates correction data Z(x, y) that approximates the unevenness in the density of the radiographic image by using pixel values in the area that has substantially the same density throughout the area, which has been obtained by the area obtainment unit 10. Further, the correction processing unit 22 uses the correction data generated by the correction data generation unit 21, and corrects the pixel values of the radiographic image P to generate corrected image S. Next, the display unit 40 displays the corrected image S generated by the correction processing unit 22, the correction data Z(x, y) that has been used for the correction processing, the border of the area that has substantially the same density throughout the area, the area having been used to generate the correction data Z(x, y) or the like on the monitor.

When the user inputs a corrected value for a parameter displayed on the screen by using the input unit 30, the correction data generation unit 21 receives the corrected value input by the user from the input unit 30. Further, the correction data generation unit 21 corrects the parameter by using the corrected value that has been input by the user. Further, the correction processing unit 22 uses a function defined by the corrected parameter, and corrects the pixel values of the radiographic image again to generate corrected image S, the unevenness in the density of which has been corrected. Further, the recording unit 50 stores corrected image S that has been finally produced, and the unevenness in the density of which has been corrected, and the correction data Z(x, y) that has been used for the correction processing in a recording medium. The image S and the corrected data Z(x, y) are stored in such a manner that they relate to each other.

In the above-described case, the correction data Z(x, y) generated by the correction data generation unit 21 is directly used to generate the corrected image S, and the result of processing is presented to the user (by displaying on a monitor or the like), and the correction data is corrected if necessary, and the corrected correction data is used to perform correction processing again. Alternatively, before the first correction processing is performed, the correction data Z(x, y) generated by the correction data generation unit 21, the border of the area that has substantially the same density throughout the area, the area having been used to generate the correction data Z(x, y) or the like may be temporarily displayed on the monitor. Then, if necessary, the user inputs an instruction for correcting the correction data, and the correction processing unit 22 receives the corrected correction data. Further, the correction processing unit 22 may perform correction processing by using the corrected correction data.

According to the above embodiment, when pixel values of a radiographic image that has been obtained by outputting radiation from a radiation output means toward the subject and by detecting the radiation at a radiographic image detector are corrected, an area that has substantially the same density throughout the area when the radiation output by the radiation output means is uniform with respect to the entire area of the radiographic image detector and that is present in a subject-image-present area of the radiographic image is obtained. Further, the pixel values of the radiographic image are corrected by using pixel values of the obtained area. Therefore, it is possible to correct even non-recurrent unevenness, which does not recur nor repeat (reappear), based on the influence of unevenness in irradiation (irradiation dose) that appears in the pixel values of the area that should have substantially the same density throughout the area when the radiation output by the radiation output means is uniform with respect to the entire area of the radiographic image. Hence, it is possible to correct even the non-recurrent unevenness, regardless of whether a non-subject-imaged area is present in the radiographic image.

Further, in the present invention, when both of the lengths of the overlapped-ribs-image-present areas, which have substantially the same density throughout the areas when the radiation output by the radiation output means is uniform with respect to the entire area of the radiographic image, in the longitudinal direction thereof are greater a predetermined threshold value, if a non-linear function is used, the non-linear function can more accurately approximate the unevenness in the density of the radiographic image than a linear function. In contrast, when at least one of the lengths of the overlapped-ribs-image-present areas in the longitudinal direction thereof is less than or equal to a predetermined threshold value, if a non-linear function is used to approximate the unevenness, there is a risk that inappropriate correction data is generated. Therefore, in that case, it is desirable that the correction data is generated by using a linear function.

Further, in the above embodiment, when the radiographic image is an anterior view of the chest of a human body, a case in which the area obtainment unit 10 obtains, as the area that has substantially the same density throughout the area, overlapped-ribs-image-present areas from the radiographic image of the anterior view of the chest, overlapped ribs in the overlapped-ribs-image-present areas being present in a left lateral-border region of the thorax of the human body and in a right lateral-border region thereof was described as an example. However, the area is not limited to the overlapped-ribs-image present areas. For example, as illustrated in FIG. 5, the area obtainment unit 10 may obtain, as the area that has substantially the same density throughout the area, shoulder-blade-image-present areas B (areas enclosed by solid white lines in FIG. 5) from the radiographic image. The shoulder blades (scapulae) in the shoulder-blade-image-present areas B are present on the outside of the left superior region of the thorax of the human body and on the outside of the right superior region thereof. Further, correction data that approximates the unevenness in the density of the radiographic image, the unevenness being present in a direction orthogonal to the body axis of the subject in the radiographic image, may be generated by using the pixel values in the areas B. Further, the generated correction data may be subtracted from the radiographic image. Accordingly, it is possible to correct non-recurrent unevenness in a direction orthogonal to the body axis in the entire area of the radiographic image. The areas B are symmetrical with respect to the body axis, and they are present on the outside of the thorax (the outside of the thorax is not influenced by the lung fields, which may be asymmetric). The areas B are practically used because they can be regarded as areas that have substantially the same density throughout the areas, and they are in the radiographic image of the anterior view of the chest in most of the cases (at high probability).

The shoulder-blade-image-present areas B may be obtained by providing a program for automatically determining the shoulder-blade-image-present areas B in the area obtainment unit 10. Further, the program is used to cause a computer to execute the procedure for extracting the lateral borders of the left and right lung fields, for example, by using the technique disclosed in Japanese Unexamined Patent Publication No. 2003-006661, and the procedure for setting triangle areas B, as illustrated in FIG. 5, on the outside of the superior regions of the lung fields. Here, the triangle areas B may be set in the following manner. First, the upper side of a triangle, the upper side extending in a direction orthogonal to the body axis, is set in such a manner that the height (position with respect to the vertical direction) of the upper side of the triangle becomes the same as the height of the superior border of the lung fields. Further, the side of the triangle, the side closer to the center of the lung, is set in such a manner that the side contacts with the thorax in the superior region (upper region) of the lung (a border formed by overlapped ribs). Next, the length of the upper side of the triangle is set at a predetermined value (for example, ½ of the maximum distance between the body axis and the lateral border of the lung fields). Further, the remaining side of the triangle, in other words, the lateral side is set in such a manner that the lateral side is parallel to the body axis.

The area obtainment unit 10 may automatically obtain the shoulder-blade-image-present areas B, which have substantially the same density throughout the areas, as described above. Alternatively, the user may input information about the positions of points that surround (enclose) the areas, or information that specifies actual position of the shoulder-blade-image-present areas B. The information that specifies the positions of the areas B is input by painting the entire area of the areas B or the like. The information should specify the areas B in such a manner that the areas are uniquely identified based on the information. Further, the shoulder-blade-image-present areas B may be obtained based on the input information or the like.

What is claimed is:

1. A radiographic image correction method for correcting pixel values of a radiographic image of a subject, the radiographic image having been obtained by outputting radiation from a radiation output means toward the subject and by detecting the radiation at a radiographic image detector, the method comprising the steps of:
obtaining an area that has substantially the same density throughout the area when the radiation output by the radiation output means is uniform with respect to the entire area of the radiographic image detector and that is present in a subject-image-present area of the radiographic image; and
correcting the pixel values of the radiographic image by using pixel values of the obtained area.

2. A radiographic image correction apparatus for correcting pixel values of a radiographic image of a subject, the radiographic image having been obtained by outputting radiation from a radiation output means toward the subject and by detecting the radiation at a radiographic image detector, the apparatus comprising:
an area obtainment means that obtains an area that has substantially the same density throughout the area when the radiation output by the radiation output means is uniform with respect to the entire area of the radiographic image detector and that is present in a subject-image-present area of the radiographic image; and
a correction means that corrects the pixel values of the radiographic image by using pixel values of the obtained area.

3. A radiographic image correction apparatus, as defined in claim 2, wherein the radiographic image is a radiographic image of an anterior view of the chest of a human body, and wherein the area obtainment means obtains, as the area that has substantially the same density throughout the area, overlapped-ribs-image-present areas from the radiographic image of the anterior view of the chest, overlapped ribs in the overlapped-ribs-image-present areas being present in a left lateral-border region of the thorax of the human body and in a right lateral-border region thereof.

4. A radiographic image correction apparatus, as defined in claim 2, further comprising:
an area specifying information input means that is used to input information specifying the area that has substantially the same density throughout the area, wherein the area obtainment means obtains the area that has substantially the same density throughout the area based on the information input by the area specifying information input means.

5. A radiographic image correction apparatus, as defined in claim 2, wherein the correction means obtains a linear function that approximates unevenness in the density of the radiographic image by using pixel values of the area that has substantially the same density throughout the area, and corrects the pixel values of the radiographic image by using the obtained linear function.

6. A radiographic image correction apparatus, as defined in claim 3, further comprising:
an area specifying information input means that is used to input information specifying the area that has substantially the same density throughout the area, wherein the area obtainment means obtains the area that has substantially the same density throughout the area based on the information input by the area specifying information input means.

7. A radiographic image correction apparatus, as defined in claim 3, wherein the correction means obtains a linear function that approximates unevenness in the density of the radiographic image by using pixel values of the area that has substantially the same density throughout the area, and corrects the pixel values of the radiographic image by using the obtained linear function.

8. A radiographic image correction apparatus, as defined in claim 3, wherein the correction means obtains a linear function that approximates unevenness in the density of the radiographic image by using pixel values of the overlapped-ribs-image-present areas when at least one of the lengths of the overlapped-ribs-image-present areas in the longitudinal direction thereof is less than or equal to a predetermined threshold value, and corrects the pixel values of the radiographic image by using the obtained linear function, and wherein the correction means obtains a non-linear function that approximates the unevenness in the density of the radiographic image by using the pixel values of the overlapped-ribs-image-present areas when both of the lengths of the overlapped-ribs-image-present areas in the longitudinal direction thereof are greater than the predetermined threshold value, and corrects the pixel values of the radiographic image by using the obtained non-linear function.

9. A radiographic image correction apparatus, as defined in claim 4, wherein the correction means obtains a linear function that approximates unevenness in the density of the radiographic image by using pixel values of the area that has substantially the same density throughout the area, and corrects the pixel values of the radiographic image by using the obtained linear function.

10. A radiographic image correction apparatus, as defined in claim 5, further comprising:
a display means that displays a parameter of the function that approximates the unevenness in the density; and
a corrected-value input means that is used to input a corrected value to correct the parameter displayed by the display means, wherein the correction means corrects the parameter by using the corrected value input by the corrected-value input means, and corrects the pixel values of the radiographic image by using a function defined by the corrected parameter.

11. A radiographic image correction apparatus, as defined in claim 5, further comprising:
a storage means that stores the function that has been used by the correction means to correct the pixel values in such a manner that the function relates to the radiographic image, the pixel values of which have been corrected by using the function.

12. radiographic image correction apparatus, as defined in claim 8, further comprising:
a display means that displays a parameter of the function that approximates the unevenness in the density; and
a corrected-value input means that is used to input a corrected value to correct the parameter displayed by the display means, wherein the correction means corrects the parameter by using the corrected value input by the corrected-value input means, and corrects the pixel values of the radiographic image by using a function defined by the corrected parameter.

13. A radiographic image correction apparatus, as defined in claim 8, further comprising:
a storage means that stores the function that has been used by the correction means to correct the pixel values in such a manner that the function relates to the radiographic image, the pixel values of which have been corrected by using the function.

14. A radiographic image correction apparatus, as defined in claim 10, further comprising:
a storage means that stores the function that has been used by the correction means to correct the pixel values in such a manner that the function relates to the radiographic image, the pixel values of which have been corrected by using the function.

15. A radiographic image correction apparatus, as defined in claim 2, wherein the radiographic image is a radiographic image of an anterior view of the chest of a human body, and wherein the correction means extracts a body axis of the human body from the radiographic image of the anterior view of the chest, and obtains a function that approximates unevenness in the density of the radiographic image of the anterior view of the chest, the unevenness in the density being present in a direction orthogonal to the extracted body axis, by using the pixel values of the area that has substantially the same density throughout the area, and corrects pixel values of the radiographic image of the anterior view of the chest by using the obtained function.

16. A radiographic image correction apparatus, as defined in claim 15, further comprising a target specifying information input means that is used to input information that specifies whether both of unevenness in the density of the radiographic image, the unevenness in the density being present in the direction of the body axis, and the unevenness in the density in the direction orthogonal to the body axis, or only the unevenness in the density in the direction orthogonal to the body axis is a target of correction processing by the correction means, wherein the correction means obtains, based on the information input by the target specifying information input means, one of a function that approximates both of the unevenness in the density in the direction of the body axis and the unevenness in the density in the direction orthogonal to the body axis and a function that approximates the unevenness in the density in the direction orthogonal to the body axis, and corrects the pixel values of the radiographic image by using the obtained function.

17. A computer-readable recording medium stored therein a radiographic image correction program for causing a computer to execute radiographic image correction processing for correcting pixel values of a radiographic image of a subject, the radiographic image having been obtained by outputting radiation from a radiation output means toward the subject and by detecting the radiation at a radiographic image detector, the program comprising the procedures of:
obtaining an area that has substantially the same density throughout the area when the radiation output by the radiation output means is uniform with respect to the entire area of the radiographic image detector and that is present in a subject-image-present area of the radiographic image; and
correcting the pixel values of the radiographic image by using pixel values of the obtained area.
